(19) United States
(12) Patent Application Publication
(10) Pub. No.: US 2014/0101249 A1
(43) Pub. Date: Apr. 10, 2014

(54) Systems and Methods for Managing and Presenting Information

(71) Applicant: MARK LAMPE, Scottsdale, AZ (US)

(72) Inventor: MARK LAMPE, Scottsdale, AZ (US)

(21) Appl. No.: 13/938,843

(22) Filed: Jul. 10, 2013

Related U.S. Application Data
(60) Provisional application No. 61/669,827, filed on Jul. 10, 2012.

(51) Int. Cl. H04L 29/06

(52) U.S. Cl. CPC H04L 65/403
USPC 709/204

(57) ABSTRACT

Systems and methods for managing and presenting information may receive listing information, create a website based on the listing information, create a social network post based on the listing information and/or the website, and submit the social network post to the social network. Systems and methods for managing and presenting information therefore may integrate the website with the social network post by facilitating the presentation of related information on the website and the social network post. Systems and methods for managing and presenting information may optimize the website and/or social network post to improve the probability that the website and/or social network post will be viewed, such as affecting the visibility of website and/or social network post in search engine results. The listing information may correspond to any good or service listed for a transaction, for example, a real estate listing.

### CROSS-REFERENCES TO RELATED APPLICATIONS

This application claims the benefit of U.S. Provisional patent application No. 61/669,827, filed Jul. 10, 2012, titled METHODS AND APPARATUS FOR AUTOMATICALLY UPLOADING INFORMATION TO SOCIAL NETWORKS, and incorporates its disclosure by reference.

### BACKGROUND OF THE INVENTION

When the owner or provider of a good or service desires to initiate a transaction of the good or service, the owner or provider may list the good or service on a traditional listing service, such as a multiple listing service for real estate, a classified ad listing service, and the like. If the owner or provider desires to list the good or service on more than one listing service, the owner or provider is required to repeatedly enter the same information about the good or service on each listing service. In addition, a listing on a traditional listing service is only viewable to a user of the listing service. If the owner or provider desires to make the listing available to other user networks, such as on a social media network, the owner or provider is required to enter listing information for each such network. Further, traditional listing services do not optimize the probability that the listing will be viewed by the appropriate buyers of the good or service. These factors inhibit a comprehensive and integrated approach to presenting and viewing listing information across multiple platforms.

### SUMMARY OF THE INVENTION

Systems and methods for managing and presenting information may receive listing information, create a website based on the listing information, create a social network post based on the listing information and/or the website, and submit the social network post to the social network. Systems and methods for managing and presenting information therefore may integrate the website with the social network post by facilitating the presentation of related information on the website and the social network post. Systems and methods for managing and presenting information may optimize the website and/or social network post to improve the probability that the website and/or social network post will be viewed, such as affecting the visibility of website and/or social network post in search engine results. The listing information may correspond to any good or service listed for a transaction, for example, a real estate listing.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a system for managing and presenting information;

FIG. 2 representatively illustrates a method for managing and presenting information;

FIG. 3 representatively illustrates a registration process;

FIG. 4 representatively illustrates a user dashboard;

FIG. 5 representatively illustrates a process for determining available social networks;

FIG. 6 representatively illustrates a user website;

FIG. 7 representatively illustrates an exemplary embodiment of a listing server;

and

FIG. 8 representatively illustrates an exemplary embodiment of a listing server communicatively linked with a user computer.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ systems, technologies, algorithms, devices, designs, services and the like, which may carry out a variety of functions. In addition, the present invention may be practiced in conjunction with any number of hardware and software applications and environments, such as websites, social network mediums, and applications configured to link users, and the system described is merely one exemplary application for the invention.

The present invention may also involve multiple programs, functions, computers and/or servers. While the exemplary embodiments may described in conjunction with conventional computers, the various elements and processes may be implemented in hardware, software, or a combination of hardware, software, and other systems. Software and/or software elements according to various aspects of the present invention may be implemented with any software language or standard, such as, for example, MultiDimensional eXpressions language (MDX), AJAX, C, C++, Java, COBOL, assembly, PERL, eXtensible Markup Language (XML), PHP, etc., or any other programming, scripting, query, or other software language or standard, whether now known or later developed. Further, the present invention may employ any number of conventional techniques for providing systems and methods for managing and presenting information.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Systems and methods for managing and presenting information according to various aspects of the present invention may operate in conjunction with any suitable telecommunication network, real estate information system or service such as a listing service or an aggregator, computing process or machine, phone, smart phone, tablet, server, navigation system, or other device with access to a telecommunication network, such as the Internet. Various representative implementations of the present invention may be applied to any electronic device or application configured to generate a web page or a social network post based on real estate listing information, and to optimize the web page or social network post to increase the probability that the web page or social network post will be viewed, such as increasing a corresponding search engine page rank.

Various representative algorithms may be implemented with any combination of data structures, objects, processes, routines, other programming elements, computing components, units, and/or devices, and the like. Further, the present invention may employ any number of conventional techniques for data transmission, signaling, data processing, network control, and/or the like. Applications according to various aspects of the present invention may be formulated and a network may be provided that may include any system for exchanging data, such as, for example, a telecommunication network such as the Internet, an intranet, an extranet, WAN, LAN, satellite communications, and/or the like. The network may be implemented as other types of networks, such as an interactive television (ITV) network. The users may interact with the system by any input device such as a keyboard, mouse, kiosk, personal digital assistant, handheld computer, cellular phone such as a Smartphone that may have access to the internet, text messaging by cellular phone and/or the like.

Similarly, the invention may be used in conjunction with any type of personal computer, network computer, workstation, minicomputer, mainframe, or the like running any operating system such as any version of Windows, Android, Mac OS X, OS/2, BeOS, Linux, UNIX, or any other operating system, whether now known or hereafter developed. Moreover, the invention may be implemented with TCP/IP communications, IPX, AppleTalk, IP-6, NetBIOS, OSI or any number of existing or future protocols. The various computing devices described herein may be referred to as computing units.

A computing unit may comprise conventional components, such as a processor, a local memory such as RAM, long term memory such as a hard disk, a network interface, and any number of input and/or output peripherals such as a keyboard, mouse, monitor, touch screen, and the like. The various memories of the computing unit may facilitate the storage of one or more computer instructions, such as a software routine and/or software program, which may be executable by the processor to perform the methods of the invention. A computing unit may be referred to as a computer, a computing component, a computing device, and the like. A computing unit may comprise a personal computer, server, mobile phone, smart phone, tablet computer, kiosk, and the like. Further, the databases, systems, and/or components of the present invention may consist of any combination of databases, systems, and/or components at a single location or at multiple locations. Each database, system, and/or component of the present invention may comprise any suitable security features, such as firewalls, access codes, encryption, de-encryption, compression, decompression, and/or the like.

The computing units may be connected with each other by a telecommunication network. The telecommunication network may comprise a collection of terminal nodes, links, and any intermediate nodes, which are connected to enable communication at a distance between the terminal nodes. A telecommunication network may be simply referred to as a network. In some embodiments, a terminal node may comprise a computing unit. The computing units and telecommunication network may facilitate cloud computing. The network may be a public network and assumed to be insecure and open to eavesdroppers. The network may also be a private network and assumed to be secure and closed to eavesdroppers. In one exemplary implementation, the network may be embodied as the Internet. In this context, computers may or may not be connected to the Internet at all times.

Telecommunication may be accomplished through any suitable communication system, such as, for example, a telephone network, intranet, Internet, point of interaction device (point of sale device, personal digital assistant, cellular phone, kiosk, etc.), online communications, off-line communications, wireless communications, a radio dispatch network, and/or the like.

A variety of conventional communications media and protocols may be used for the communication links, such as, for example, Bluetooth, a connection to an Internet Service Provider (ISP) over the local loop as is typically used in connection with standard modem communication, wireless cellular communication, cable modem, Dish networks, ISDN, Digital Subscriber Line (DSL), and/or various wireless communication methods. Polymorph code systems might also reside within a local area network (LAN) which interfaces to a network through a leased line (T1, T3, etc.). A communicative link may comprise any form or method for communication, such as a computer network, communication between software routines, and the like. A communicative link may comprise any intermediary device, system, method, and the like, between the two items so linked.

The present invention may be embodied as a method, a system, a device, and/or a computer program product. Accordingly, the present invention may take the form of an entirely software embodiment, an entirely hardware embodiment, or an embodiment combining aspects of both software and hardware. The methods of the present invention may be performed by a single computing unit, or may be performed by any combination of multiple computing units. The systems of the present invention may comprise cloud computing, and the methods of the present invention may be performed using cloud computing. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices, USB memory keys, and the like.

Systems and methods for managing and presenting information may receive listing information, create a web page based on the listing information, create a social network post based on the listing information and/or the web page, and submit the social network post to the social network. Systems and methods for managing and presenting information therefore may integrate the web page with the social network post by facilitating the presentation of related information on the web page and the social network post. Systems and methods for managing and presenting information may optimize the web page and/or social network post to improve the probability that the web page and/or social network post will be viewed. For example, systems and methods for managing and presenting information may affect the visibility of the website and/or the social network post in an internet search engine's search results, such as by facilitating the website and/or social network post to appear earlier or to be more highly ranked in un-paid search engine results.

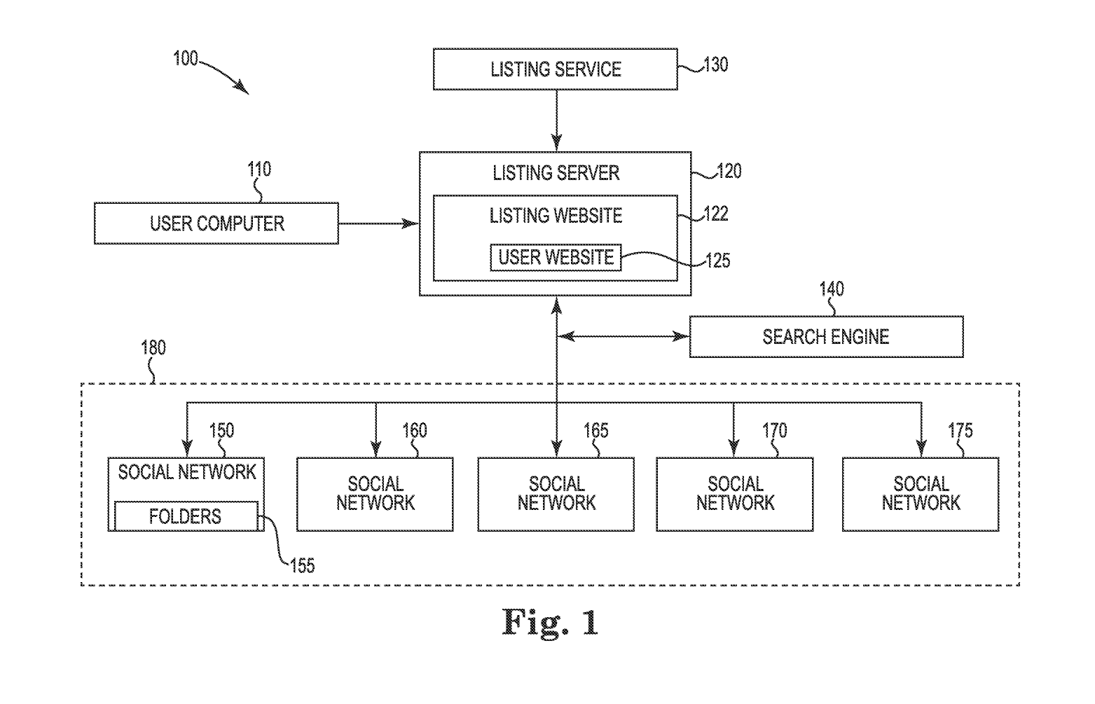

Referring to FIG. 1, a system for managing and presenting information 100 according to the present invention may comprise a listing server 120 operating a user website 125. The listing server 120 may operate a listing website 122. The user website 125 may or may not be organized under and/or accessible through the listing website 122. The listing server 120 may be communicatively linked with a user computer 110, a listing service 130, and one or more social networks 150, 160, 165, 170, 175 (collectively 180). A search engine 140 may be communicatively linked with the listing server 120 and/or the social networks 180 to analyze the user website 125, listing website 122, and/or a post on the social network 180.

The user computer 110 may comprise any suitable system capable of accessing a telecommunication network, such as the Internet, and receiving user input and/or presenting information to the user. For example, the user computer 110 may comprise a computing unit such as a conventional personal computer, a smart phone, a tablet computer, and the like. The user computer 110 may also comprise a software application, such as a web browser, a smartphone application, an email program, an instant messaging program, and the like.

A user may comprise any person or entity perceiving, interacting with, or otherwise associated with the listing website 122, user website 125, a social network 180, and/or a social network post. For example, the user may comprise a person or entity offering a good or service for a transaction such as an owner of real estate or a real estate agent for the owner. For further example, the user may comprise a person or entity attempting to find a good or service, such as a prospective purchaser of real estate or a real estate agent for the purchaser.

The listing server 120 may comprise any suitable system capable of accessing a telecommunication network, such as the Internet, receiving listing information, creating and/or updating a website, and updating and/or generating a social network post. For example, the listing server 120 may comprise a particularly programmed computing unit such as a conventional personal computer, network server, a smart phone, a tablet computer, and the like. The listing server 120 may also comprise a software application configured to perform one or more steps of the present invention, such as a configured web server application, smartphone application, email program, instant messaging program, and the like. The listing server 120 may operate the listing website 122, under which one or more user websites 125 may be organized. In an alternative embodiment, one or more user websites 125 may be organized independently from the listing website 122. The listing server 120 may perform one or more methods of the present invention, and the user website 125 and/or listing website 122 may facilitate the performance of the one or more methods, such as by providing a user interface, providing programming logic, and the like.

A listed item may comprise any good or service made available for a transaction. For example, a listed item may comprise an item for sale on an auction website such as eBay® or through a classified ad service such as craigslist®. In one embodiment, the listed item may comprise real estate. The transaction may comprise the sale, rent, lease, exchange, and the like of the good or service. A listing may reference the listed item and may comprise information corresponding to the listed item. For example, the listing may comprise information, such as, price, features, amenities, location, age, description, and the like. In one embodiment, the listing may comprise a real estate listing. The listing and/or the information contained in the listing may be referred to as listing information.

The listing website 122 may comprise any suitable hardware and/or software system. The listing website 122 may comprise a conventional website found on the World Wide Web. The listing website 122 may comprise a collection of user and nonuser websites as well as utilities for creating, editing, and deleting of a user account and user websites 125.

The listing website 122 may also comprise a search function for finding user websites 125 based on one or more search terms. The listing website 122 may facilitate geo-location capabilities, which are described below. The listing website 122 may be configured to facilitate account management capabilities. The listing website 122 and/or the user website 125 may also be configured to be indexed by the search engine 140. For example, the listing website 122 and/or the user website 125 may comprise meta tags, public keywords, sitemap files, configured URLs, and the like.

The user website 125 may comprise one or more web pages that may comprise listing information. The website 125 may comprise one or more files that are not intended for viewing by a typical website visitor, such as a sitemap file, a Cascading Style Sheet (CSS) file, and the like. For example, the user website 125 may comprise one or more web pages comprising written information, maps, pictures, slideshows, video, and the like, and may comprise a sitemap XML file. In one embodiment, the listing information may correspond to a property that is for rent, sale, lease, exchange, and the like. For example, the listing information may comprise terms and conditions, timelines, and property information such as number of bedrooms, number of bathrooms, square footage, lot size, types of rooms in the property, dimensions of rooms, home owner association rules, the property address, and other property features or description.

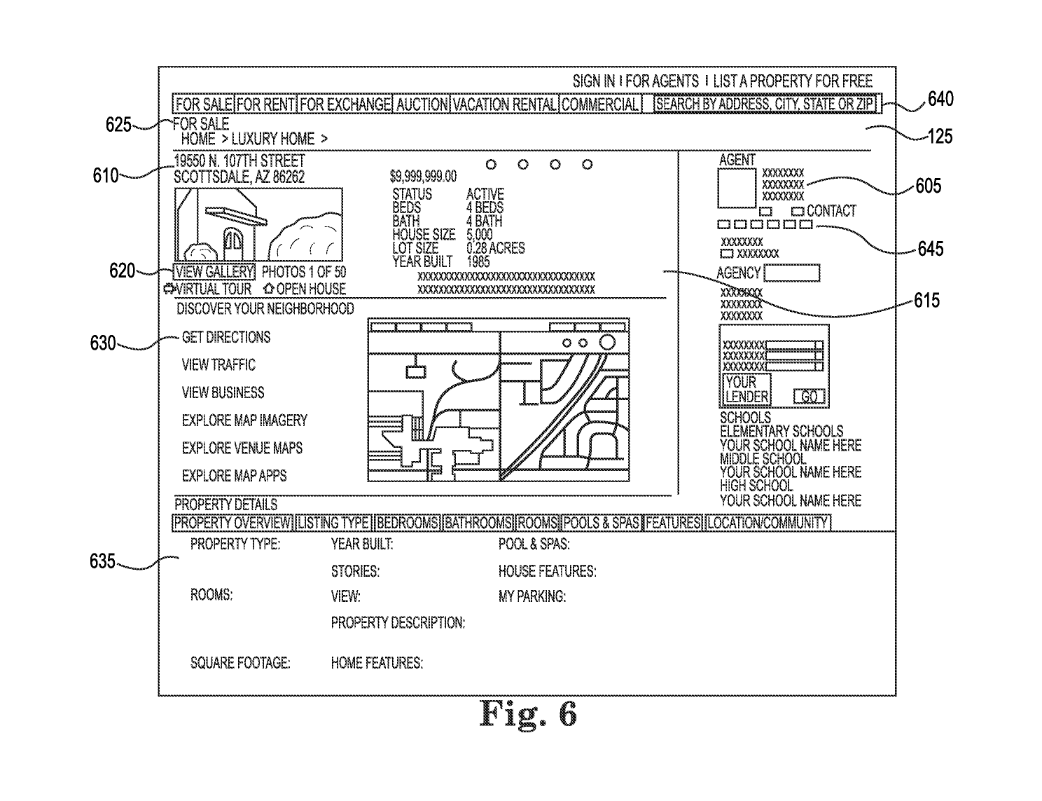

For example, referring to FIG. 6, the user website 125 may comprise listing information for real estate property. The user website 125 may comprise information about the agent and agency associated with the property 605, address information 610, pricing and other overview information 615, one or more photographs 620, a transaction type 625, driving directions and other mapping information 630, property details such as number of rooms and square footage 635, a search feature 640, social network features 645 such as an option to post to a social network or view a social network associated with the user website, such as a real estate agent's social network, and the like.

When the user is attempting to find a good or service, the listing server 120 may provide search capability on the listing website 122 and/or the user website 125 to allow searching for one or more user websites 125. In one embodiment, the listing website 122 may present search results to the user, and may present an option to post one or more of the results to a social network 180. In one embodiment, the user may select a search result and the listing server 120 may present the user website 125 corresponding to the selected search result, and the user website 125 may present an option to generate and submit a social network post (to be discussed in further detail below) based on the user website 125. The listing server 120, listing website 122, and/or user website 125 may generate and submit the social network post to a social network 180 associated with the user.

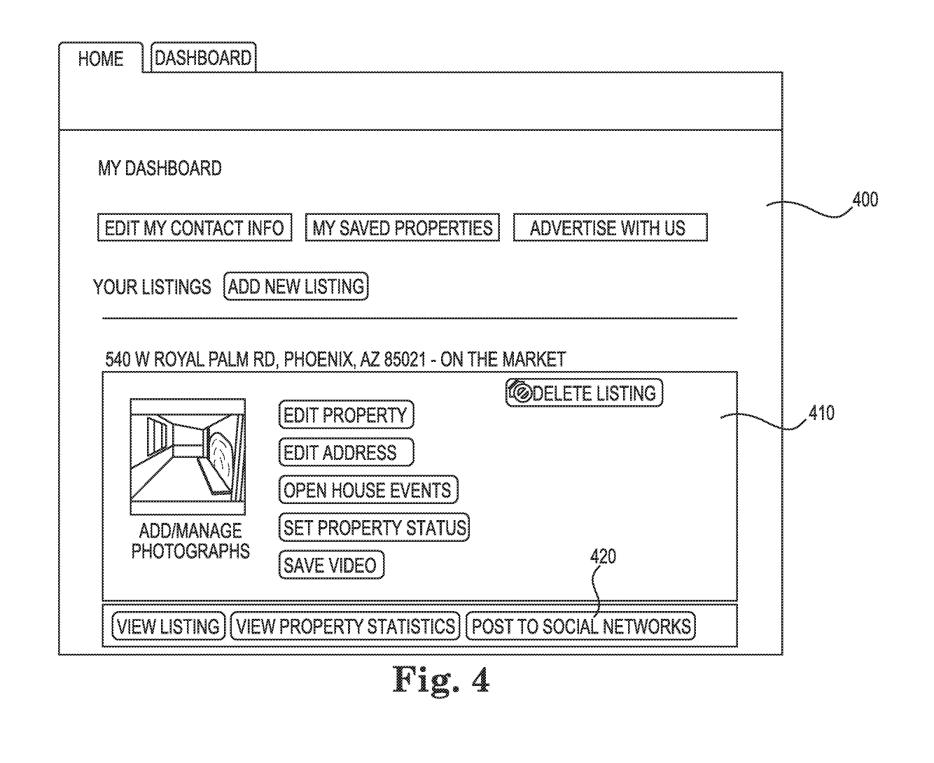

Referring now to FIG. 4, the listing website 122 and/or the user website 125 may comprise a user dashboard 400. Alternatively, the user dashboard 400 may be provided by the listing server 120 through a software application independently of the listing website 122 and the user website 125. The user dashboard 400 may be configured to allow the user to update 410 the user website 125. In an exemplary embodiment, the user website may correspond to a real estate property, and the user dashboard 400 interface may allow the user to edit the property information, edit the property address, add open house events, add photographs, add or create videos and/or slideshows, adjust the property status, delete the user website, and the like. In one embodiment, the user dashboard 400 may comprise an option 420 to generate and/or submit a post to one or more social networks 180 (to be discussed in further detail below).

Referring again to FIG. 1, the listing service 130 may comprise any source of listing information relevant to the subject matter of the user website 125 and/or the listing website 122. In one embodiment, the listing service 130 is accessible using a telecommunication network, such as the Internet. For example, if the user website 125 corresponds to a listing for a home for sale, the listing service 130 may comprise a real estate listing service such as a multiple listing service, a real estate listing aggregator such as ListHub®, and the like. In another example, the user website 125 may comprise a listing for a bike for sale, and the listing service 130 may comprise a craigslist® post.

The search engine 140 may comprise any hardware and/or software system configured to search for information available on a telecommunication network, such as the Internet. For example, the search engine 140 may comprise Google®, Yahoo®, Bing®, Baidu, Ask.com, and the like. Search terms may be provided to the search engine 140, and the search engine 140 may list (or “rank”) search results according to a determined relevance to the search terms. Search results may comprise a link and/or a description of a web page. The search engine 140 may determine relevance using any suitable system or method. For example, the search engine 140 may rank the search results according to how closely the search terms match the contents of the web page and/or meta elements contained in the web page source code, elements contained in a sitemap XML file associated with the web pag, the URL of the web page, and the like.

The social network 180 may comprise any computerized system and/or method for presenting information provided by a first user of the social network 180 to a second user of the social network 180. The social network 180 may facilitate the sharing information among two or more users of the social network 180 and may comprise a website and/or a software application. The social network 180 may comprise a social networking service such as Facebook®, Google+®, Twitter®, and the like. The social network 180 may comprise a social media website such as YouTube®, Pinterest®, Wikipedia®, and the like. The social network 180 may comprise networks such as LinkedIn® , ImageShack®, Photobucket®, a blog, and the like. The social network 180 may comprise a Rich Site Summary feed, often referred to as a Really Simple Syndication feed or RSS feed. In some embodiments, an interface to the social network 180 may be embedded in the listing website 122 and/or user website 125.

For example, Facebook® allows the first user to make a comment, reply to a comment from the second user, indicate the first user likes a comment made by the second user, upload a picture viewable by the second user, and the like. A user may interface with Facebook® through the Facebook website, and may interface with Facebook through an Facebook interface embedded in a separate website. For further example, YouTube® allows the first user to upload a video and provide a video description viewable by the second user. The social network may facilitate one-way and/or two-way interaction between the first user and the second user.

The information to be submitted to the social network 180 by the first user for presentation to the second user may be termed a “social network post,” or a “post” for short. The act of submitting information to the social network 180 is sometimes referred to as “posting.” A social network post may comprise any type of information presented in any suitable manner. For example, a social network post may comprise text, a HTTP hyperlink such as a backlink, a video, an audio clip, a picture, and the like. For further example, a social network post may comprise a tweet in the case of Twitter®, a pin or pinboard in the case of Pinterest®, a blog post, a save list, a directory submission, a YouTube video, and the like.

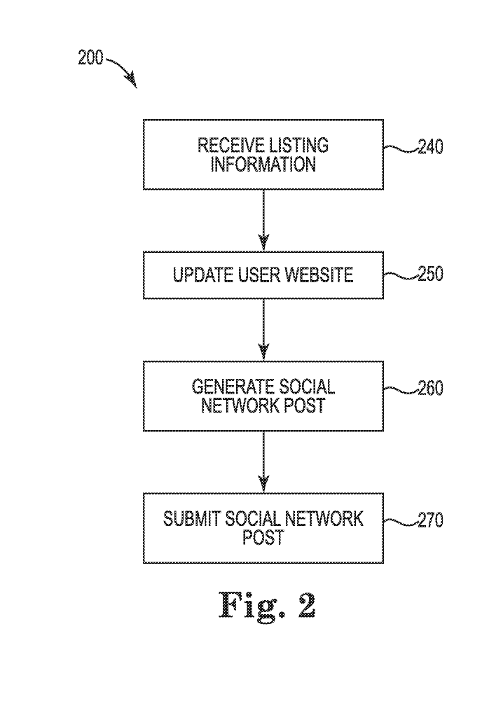

Referring now to FIG. 2, a method for managing and presenting information 200 may comprise receiving listing information (240), updating the user website (250), generating the social network post (260), and submitting the social network post (270).

Receiving the listing information (240) may comprise actively retrieving the listing information and/or passively receiving the listing information from a source of listing information. In one embodiment, receiving listing information (240) may comprise the listing server 120 receiving listing information in response to a request from the listing server 120 for listing information. For example, receiving listing information (240) may comprise presenting a web form on the listing website 122 and/or user website 125, and receiving the information submitted through the web form. In one embodiment, receiving listing information (240) may comprise the listing server 120 receiving listing information without previously requesting it. The listing information may be received from any suitable source, such as the listing service 130 or the user through the user computer 110.

In some embodiments, the listing information may be pre-formatted into one or more fields. For example, a user, through the user computer 110, may provide listing information using a web form provided by the listing website 122 and/or user website 125, wherein one or more web form entries may correspond to a particular field, such as a real estate property description, price, square footage, and the like. For further example, the listing service 130 may store the listing information according to various fields, and may provide the listing information according to the various fields. In one embodiment, receiving the listing information (240) may comprise storing the listing information in a long-term storage, such as in a computerized database or in an XML file, and may store the listing information according to the one or more fields. The received listing information may be used as it is received and/or may be retrieved from storage before use.

In one embodiment, receiving listing information (240) may comprise determining a user associated with the listing information and assigning the listing information to the user. For example, received listing information may correspond to a first real estate agent, receiving the listing information (240) may comprise determining the first real estate agent, such as by an agent identification number, and then linking the received listing information to an account associated with the first real estate agent.

Updating the user website (250) may comprise creating or updating a web page, wherein the created or updated web page comprises at least some of the received listing information and is configured to present such listing information. In one embodiment, if a web page corresponding to the received listing information does not exist prior to updating the user website (250), then updating the user website (250) may comprise creating the web page comprising at least some of the received listing information. In one embodiment, if a web page corresponding to the received listing information (for example, associated with the same listed item) exists prior to updating the user website (250), then updating the user website (250) may comprise adding or changing listing information in the web page based on the received listing information, or alternatively may comprise deleting the existing web page and creating a new web page comprising at least some of the received listing information.

Generating a social network post (260) may comprise creating or updating a social network post, wherein the created or updated social network post comprises at least some of the received listing information and is configured to present such listing information when viewed on a social network 180. In one embodiment, if no post corresponding to the received listing information exists on the social network 180 prior to generating the social network post (260), then generating the social network post (260) may comprise creating the post comprising at least some of the received listing information. In one embodiment, if a post corresponding to the received listing information (for example, associated with the same listed item) exists on the social network 180 prior to generating the social network post (260), then generating the social network pot (260) may comprise adding or changing listing information in the post based on the received listing information, or alternatively may comprise deleting the existing post and creating a new post comprising at least some of the received listing information.

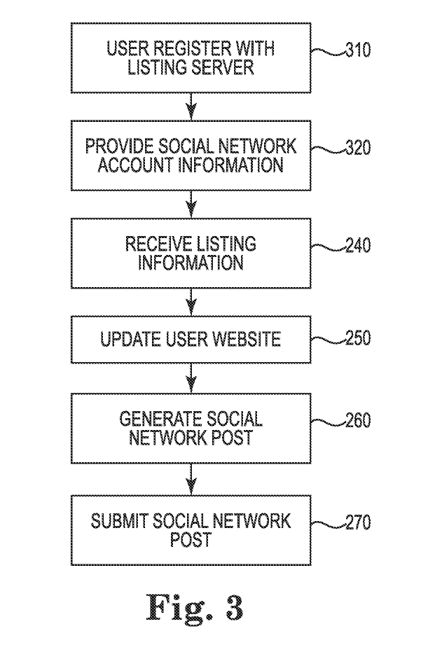

For example, and referring to FIG. 3, in one embodiment the user computer 110 may facilitate registration with the listing server 120 (310). The registration process (310) may comprise the submission of user account access information, such as login credentials, for one or more social networks 180. Once the user has registered an account, the listing information may be received (240) from the user and/or from the listing service 130. The listing information received (240) from the listing service 130 may supplement the listing information provided by the user (240). Once the registration process (310) is complete and the listing information has been received (240), the listing server 120 may update the user website 125 (250), generate the social network post (260), and submit the social network post (270) as described herein. In some embodiments, the listing server 120 may use the account access information prior to or in conjunction with submitting the social network post (270), for example by providing login credentials to the social network 180. One or more search engines 140 may index the listing website 122, the user webpage 125, and/or one or more of the social networks 180 and/or social network posts.

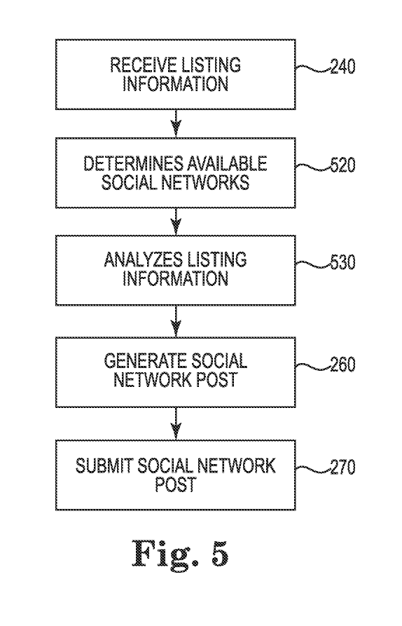

For further example, and referring to FIG. 5, in one embodiment, once the listing information has been received (240), the listing server 120 may access an account associated with the user website 125, and determine (520) which social networks are available to submit the social network post to (270). For example, the listing server 120 may access the account and determine which social networks 180 account information has been provided for. Once the listing server 120 has determined which social networks 180 are available to submit the social network post to (270), the listing server 120 may analyze the user website 125 and/or the received listing information to determine which portions of the listing information to include in the social network post (530), generate the social network post accordingly (260), and submit the post to one or more of the available social networks (270). Alternatively or additionally, the listing server 120 may search (530) for one or more predetermined fields of information in the user website 125 and/or the received listing information and generate the social network post (260) based on the one or more predetermined fields of information.

In some embodiments, determining (520) which social networks are available to submit the social network post to (270) may comprise requesting the user to select a social network 180 to post to, and may comprise requesting login credentials for the selected social network 180. The login credentials received in this manner may be used one time to submit the social network post (270) and then discarded, or may be stored for future use.

Referring again to FIG. 2, in an exemplary embodiment, if the user has provided information for logging onto YouTube, Facebook, and Twitter, and other social networks 180, the listing server 120 may select a portion (including the entirety) of the received listing information and/or the listing information available in the user website 125 that is relevant to each particular social network 180. For example, the listing server 120 may be configured to select one or more videos from the user website 125 and/or the received listing information to post to YouTube, along with a description of the listed item from the user website 125 and/or the received listing information and a hyperlink to the user website 125. The listing server 120 may be configured to select one or more pictures to post to Facebook® in a new album, post a hyperlink to the user website 125, and generate a post (260) detailing relevant information from the user webpage. The listing server 120 may be configured to select one or more pictures to tweet hyperlinks for on Twitter. The listing server 120 may also be configured to tweet a hyperlink to the user website 125 and/or or create a tweet detailing relevant information from the user website 125 and/or received listing information. As described above, generating (260) and submitting (270) a social network post may be performed by the listing server 120, and the listing website 122 and/or the user website 125 may facilitate the performance of these steps.

In one embodiment, the social network post may comprise an update to the user website 125. In one embodiment, the update may be performed using the user dashboard 400. For example, if a photograph is added to the user website 125, the social network post may comprise the added photograph. In another example, the social network post may correspond to an adjusted term or condition from the user webpage 125 such as a change in a price or the inclusion of additional features or benefits. In one embodiment, the update may be performed by the listing server 120 in response to receiving new or updated listing information (240) corresponding to the user website 125.

In one embodiment, a social network post may comprise a hyperlink to the user website 125. For example, the description of a YouTube® video may include a link to the user website 125. In another example, the hyperlink to the user website 125 may be invisibly integrated and/or embedded into the social network post. In this embodiment, a user may click on the social network post, such as a box of text or a picture, and the user may be directed to the user website 125.

In one embodiment, the listing server 120 may be configured to modify and/or further process the received listing information and/or any additional user supplied information to generate the social network post (260). For example, YouTube® may be a social network 180 available for submitting a post to (270), but the listing server 120 may not have received any videos in the received listing information. The listing server 120 may compile photos from the received listing information and/or the user website 125 to generate a slideshow video (260) and submit (270) the slideshow video to YouTube®. As further described below, the listing website 120 may be configured optimize the social network post to improve the visibility of the social network post, such as by including any meta tag data and key words from the user webpage 125 for use by YouTube® search, may be configured to include the webpage description in the video description, and may be configured to link the video with the user webpage 125 and the user's personal YouTube library.

In one embodiment, the listing server 120 may be configured to create folders or other groupings on the social network 180 for a particular user. For example, if the particular user supplied account information for Facebook®, the listing server 120 may create a folder on Facebook® based upon the subject matter of user websites 125 associated with the particular user. For example, if the user is listing a series of properties that are available for sale, rent, exchange, and the like, the listing server 120 may create folders 155 or other groupings on one or more social networks 180 based on each category of property (e.g., “For Sale,” “Rent,” “Sold,” “Vacation Rental,” “Exchange,” and the like). The folders 155 may contain appropriate listing information according to property type, and may contain a link to the corresponding user website 125. Any suitable grouping of listing information may be used.

Submitting the social network post (270) may comprise any suitable system and/or method for providing the social network post to the social network. In one embodiment, the social network may provide an application programming interface (API), and submitting the social network post (270) may comprise using the API to submit the post to the social network. In another embodiment, an API to interface with the social network may be provided by the listing server 120, listing website 122, and/or user website 125. In yet another embodiment, submitting the social network post (270) may comprise providing login credentials to the social network, such as a user name and a password, selecting to create a new post, providing the social network post, and confirming submission of the social network post.

The social network post may be generated (260) independently of the social network 180 and then submitted to the social network (270). The social network post may be created using a tool or an interface of the social network 180, such as an API, which may then facilitate the submission of the post to the social network. In some embodiments, generating the social network post (260) and submitting the social network post (270) may occur simultaneously and/or may be facilitated by the same system and/or method. For example, an API of a first social network may accept individual components of a social network post, such as a content, one or more fields, a description, one or more tags, and the like, and may simultaneously generate the complete post from the submitted components and present the social network post on the first social network.

In some embodiments, updating (250) the user website 125 and/or generating (260) and submitting (270) the social network post may be performed automatically (whether in real-time or after a delay) by the listing server 120 in response to receiving updating listing information. In one embodiment, generating (260) and submitting (270) the social network post may be performed automatically (whether in real-time or after a delay) by the listing server 120 in response to the user website 125 being updated. In some embodiments, updating (250) the user website 125 and/or generating (260) and submitting (270) the social network post may be performed at the request of the user, and/or may be performed according to predetermined preferences. For example, the predetermined preferences may indicate how many posts may be submitted to a social network 180, and how long the post will remain posted on the social network 180. The user dashboard 400 may facilitate the setting of the preferences.

In some embodiments, the user may select when to post to a social network 180, which social network 180 to post to, and/or what information to post to each social network. The selection to post to a social network 180 may be done on the user website 125, the listing website 122, and/or on the user dashboard 400. Once the election has been made to post to a social network 180, the user website 125, the listing website 122, and/or the listing server 120 may then generate (260) and submit (270) the post as described herein.

In some embodiments, updating the user website 125 (250), generating the social network post (260), and/or submitting the social network post (270) may comprise organizing and/or adding information to the user website 125 and/or the social network post to increase the probability that the user website 125 and/or social network post will be viewed or otherwise perceived. For example, certain words and phrases may be added to the user website 125 and/or social network post to increase and/or optimize the search engine page rank of the user website 125 and/or social network post.

In an exemplary embodiment, the received listing information may be parsed (240) into a database, and the user website 125 may be populated with the parsed data in a format readable by any suitable hardware or software system for retrieving, presenting and traversing information resources on a network, such a web browser. The user website 125 may be translated through a translation API into more than one human language. Key information may be extracted from the parsed data and may be used to create the address (such as a Uniform Resource Locator, or URL) of the user website 125, such as creating a long-tail URL. The key information may comprise the most sought after information when a person searches for a listed item of the type referred to by the user website 125. For example, if the user website 125 comprises listing information for a real estate property, the key information may comprise location, bedroom count, bathroom count, price, features, and the like.

The received listing information and/or the user website 125 may be scored or otherwise analyzed to determine keywords to be associated with the user website 125 and/or social network post. Keywords may comprise any word, number, abbreviation, phrase, or other recognizable combination of symbols (collectively, “words”). In an exemplary embodiment, a word contained in the listing information may be scored by determining the volume of the word, the appropriateness of the word, and the density of the word. The volume of the word may be defined as how many times (or how often) the word occurs in the listing information. The appropriateness of the word may be defined as whether or how much the word is related to the subject matter of the listing information. For example, if the listing information corresponds to a real estate property, the appropriateness of the word may be determined by judging whether the word is related to real estate. The density of the word may be defined as how many times (or how often) the word occurs out of every X words, where X can be any number. Other factors that may be used to determine keywords include whether the word appears in the first Y words of the listing information or user website 125, where Y can be any number. For example, if a word does not occur within the first 75 words of the user website 125, the word may not be used as a keyword.

The scored words may be selected as keywords using any suitable process. For example, a predetermined number of words with the highest score may be chosen as keywords. For further example, the words with a score over a certain limit may be chosen as keywords. In yet another example, the words with the highest score may be chosen as keywords up to a predetermined limit of characters. For example, if the keywords are to be used for the meta tag in the user website 125 source code, the meta tag element may have a maximum character limit and keywords may be chosen up to the maximum character limit.

In another exemplary embodiment, keywords may be determined by counting the repetitiveness of words such as nouns, verbs, adjectives, and/or adverbs to determine the repetitiveness of the words, measuring the repetitiveness as a fraction of the total word count in the user website 125, comparing the words with the highest repetitiveness against a predetermined list of ranked words, and then selecting the words with the highest repetitiveness that exist in the list of ranked words. The repetitiveness of a word may be determined by determining how many times the word occurs in the user website 125 divided by how many words occur in the user website 125. Alternatively, repetitiveness may be measured in view of the received listing information instead of the user website 125. The list of ranked words may comprise the list of the most searched terms for the given subject matter of the user website 125. In one embodiment, the determination of keywords may cease once the accumulated length of keywords reaches a predetermined character limit, such as 150 characters.

Once the keywords are determined, they may be associated with the user website 125 and/or social network post in any suitable manner. For example, the keywords may be used in a meta tag element in the user website 125, may be used in a sitemap file for the user website 125 and/or listing website 122, may be used to tag the social network post, may be used in a description for the user website 125 and/or social media post, may be used in the URL of the user website 125 and/or social network post, may be included in the properties of a video or picture, and the like.

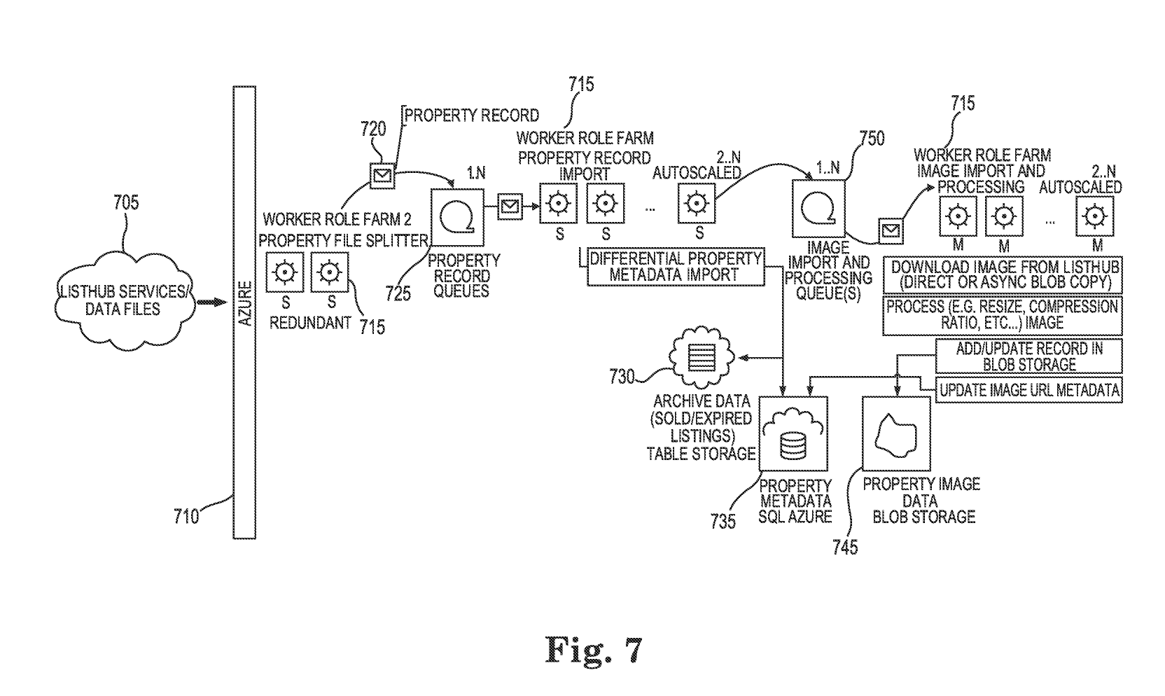

Referring now to FIG. 7, in an exemplary embodiment, the listing server 120 may comprise one or more “worker” computers 715 operating as part of a cloud application platform 710, such as Mircosoft® Azure. The cloud application platform may comprise may comprise any number of redundant worker computers 715, and may comprise a varying number of worker computer 715. For example, the number of active worker computers 715 may be dynamically and automatically scaled based on the workload to be performed by the worker computers 715. A worker computer 715 may receive listing information, such as in the form of data files, from a listing service 130, 705 such as ListHub®. The worker computer 715 may split the received listing information into individual property records 720. The property record 720 may be placed in a property record queue 725, from which the worker computer 715 may retrieve the property record 720.

The worker computer 715 may retrieve the property record 720 from the property record queue 725 and may place information from the property record 720 into a property database 735. The information from the property record 720 may analyzed and stored in the property database 735 in any suitable manner, such as organizing the information according to one or more predetermined fields. The worker computer 715 may retrieve the property record 720 from the property record queue 725 and may place one or more images from the property record 720 into an image import and processing queue 750, from which the worker computer 715 may retrieve the one or more images. The worker computer may alternatively or additionally download the one or more images from the listing service 130, for example if a link is provided in the property record 720. The worker computer 715 may perform image processing on the one or more images, such as resizing, compression, changing aspect ratio, creating a video, creating a gallery, and the like. The one or more images may then be placed into property image data storage 745, and corresponding information in the property database 735 may be updated to include information about the one or more images, such as the image URL

Information corresponding to a property record may be placed in an archive database 730 in response to certain events, such as if the intended transaction occurs (such as a property being sold) or if the listing expires. The listing server may update the user website (250) and generate the social network post (260) based on the information in the property image data storage 745 and the property database 735.

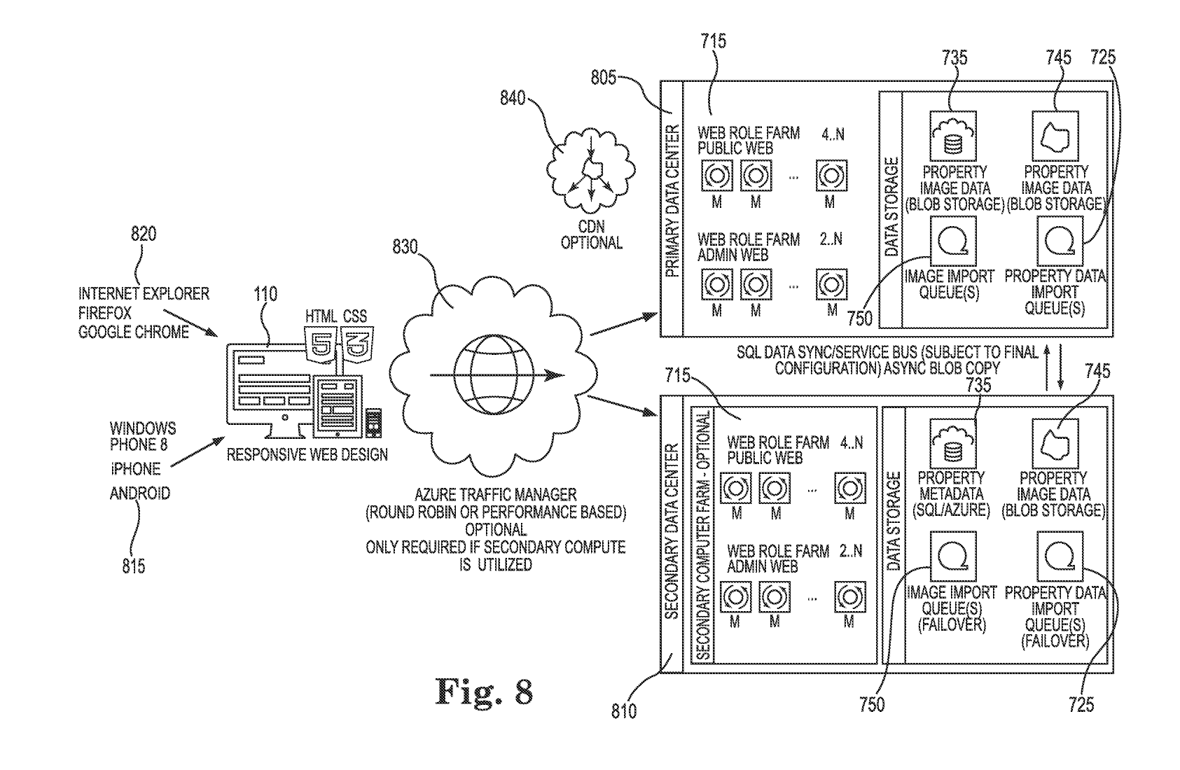

Referring now to FIG. 8, in an exemplary embodiment, the listing server 120 may comprise a primary data center 805, and may comprise a secondary data center 810. The primary data center 850 may comprise one or more worker computers 715 and a primary set of the various data storage elements 725, 735, 745, 750 described with respect to FIG. 7. The secondary data center 810 may comprise a secondary set of worker computers 715, such as backup worker computers 715, and may comprise a secondary set of the various data storage elements 725, 735, 745, 750 described with respect to FIG. 7. The secondary set of data storage elements 725, 735, 745, 750 may provide backup data storage for the primary set of data storage elements 725, 735, 745, 750.

Still referring to FIG. 8, the user computer 110 may comprise any suitable computing unit such as an Android-based smart phone, an iPhone, a Windows Phone, and the like, operating any suitable software for connecting to the listing server 120, such as the Internet Explorer, Chrome, Firefox, and the like. The user computer 110 may be communicatively linked with the primary data center 805 and/or secondary data center 810 directly, or through an internet traffic manager 830 configured to appropriately route communication between the listing server 120 and the user computer 110. In one embodiment, the primary data center 805 may be implemented in a content delivery network 840 to provide faster access to content by mirroring the various data storage elements 725, 735, 745, 750 in one or more additional data centers arranged to be more proximal the user computer 110.

Additional exemplary embodiments will now be discussed. In an exemplary embodiment, the information management and presentation systems and methods may be configured to assign a unique identifier to each property, and may be configured to send information relating to the property to a person or entity based upon a request by the person or entity. The unique identifier may comprise a number, bar code, tag, QR code, and the like. The information may comprise basic information such as number of bedrooms and price, and may comprise a link to a website relating to the property, such as the user website 125. The person or entity may request the information by texting the unique identifier to a specified phone number or account number, by using an application that visually recognizes a QR code, tag, or other visual identifier, by entering the unique identifier into a web site configured to accept the unique identifier, and the like.

The information management and presentation systems and methods may be configured to track and store data relating to the person or entity that requested the information, and may comprise the ability to provide the data to a second person or entity, such as the user. The provided data may comprise any relevant information, such as information corresponding to the device the information was requested from, such as the IP address of a computer, an email address, a telephone number, and the like. The provision of data to a second person or entity may comprise updating the user website with the data, updating an administrative website related to the listing information with the data (such as the user dashboard 400), texting or emailing the data to the second person or entity, and the like. The user dashboard 400 may allow accessing, editing, and/or setting of various data, such as assigning the unique identifier to the listed item or viewing data related to various inquiries made regarding a property.

In an exemplary embodiment, the user website 125 may be configured to facilitate the provision of listing information obtained through the use of a device. The device may be any device configured to determine information about a property. For example, the device may be a laser probe configured to determine the physical layout of the property. The information determined by the device may be converted into a three-dimensional map or model of the property that is accessible via the telecommunication network, such as through the user website 125 relating to the property.

In an exemplary embodiment, the systems and methods of the present invention may provide geo-location capabilities. For example, the listing website 122 may create a tour of open houses by facilitating user selection of one or more properties, creating one or more waypoints based on the corresponding address information for the selected properties, and then providing the waypoints to a mapping system, such as Google® Maps, through any suitable process, such as through an API. The listing server 120 and/or listing website 122 may then provide a link to or otherwise forward information about the mapped tour. In one exemplary embodiment, the user computer 110 may comprise a mobile computing unit comprising a location determination system, such as a GPS unit. A software application executing on the mobile computing unit and communicatively linked with the listing server 120, such as a web browser or smartphone application accessing the listing server 120, may determine the location of the computing unit to be near a property corresponding to a user website 125, and may cause the user website 125 to be displayed or otherwise presented on the mobile computing unit.

The systems and methods of the present invention may be configured to provide the data and information, gathered through the use of the systems and methods, to a person or entity desiring access to such data or information. For example, the data or information gathered may be formed into a residential or commercial listing for a property, and the listing may be provided to an agent, broker, listing service, or aggregator service desiring access to the listing.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A method, implemented by a computer having a processor and a memory accessible by the processor, for integrating a website corresponding to a listing information for a user with an online social network, comprising:
receiving, by the computer, the listing information;
updating, by the computer, the website according to the listing information;
generating, by the computer, a post for the online social network according to the listing information; and
submitting, by the computer, the generated post to the online social network.

2. A method according to claim 1, further comprising:
receiving, by the computer, an account access information for the online social network;
storing the access information in the memory;
retrieving, from the memory, the account access information; and
wherein submitting the generated post to the online social network comprises providing the account access information to the online social network.

3. A method according to claim 1, wherein receiving the listing information comprises receiving an input from the user.

4. A method according to claim 1, wherein receiving the listing information comprises receiving an input from a listing service.

5. A method according to claim 1, further comprising:
optimizing, by the computer, at least one of the website and the post for a search engine based on the listing information.

6. A method according to claim 5, wherein:
the website comprises a plurality of words; and
optimizing the website for a search engine comprises:
determining, by the computer, the repetitiveness of at least one of the plurality of words;
comparing, by the computer, the at least one word with a list of predetermined words;
selecting, by the computer, the at least one word with a highest repetitiveness that exists in the list of predetermined words; and
associating, by the computer, the selected word with at least one of the website and the post.

7. A method according to claim 6, wherein associating the selected word comprises placing the selected word in at least one of a sitemap for the website, a source code for the website, an address of the website, and a tag of the post.

8. A method according to claim 1, wherein the listing information comprises a real estate listing.

9. A non-transitory computer-readable medium storing computer-executable instructions for integrating a website corresponding to a listing information for a user with an online social network, wherein the instructions are configured to cause the computer to:
receive the listing information;
update the website according to the listing information;
generate a post for the online social network according to the listing information; and
submit the generated post to the online social network.

10. A non-transitory computer-readable medium storing computer-executable instructions according to claim 9, wherein the instructions are further configured to cause a computer to:
receive an account access information for the online social network;
store the access information in the memory;
retrieve, from the memory, the account access information; and
wherein submitting the generated post to the online social network comprises providing the account access information to the online social network.

11. A non-transitory computer-readable medium storing computer-executable instructions according to claim 9, wherein receiving the listing information comprises receiving an input from the user.

12. A non-transitory computer-readable medium storing computer-executable instructions according to claim 9, wherein receiving the listing information comprises receiving an input from a listing service.

13. A non-transitory computer-readable medium storing computer-executable instructions according to claim 9, wherein the instructions are further configured to cause a computer to:
optimize at least one of the website and the post for a search engine based on the listing information.

14. A non-transitory computer-readable medium storing computer-executable instructions according to claim 13, wherein:
the website comprises a plurality of words; and
optimizing the website for a search engine comprises:
determining the repetitiveness of at least one of the plurality of words;
comparing the at least one word with a list of predetermined words;
selecting the at least one word with a highest repetitiveness that exists in the list of predetermined words; and
associating the selected word with at least one of the website and the post.

15. A non-transitory computer-readable medium storing computer-executable instructions according to claim 14, wherein associating the selected word comprises placing the selected word in at least one of a sitemap for the website, a source code for the website, an address of the website, and a tag of the post.

16. A non-transitory computer-readable medium storing computer-executable instructions according to claim 9, wherein the listing information comprises a real estate listing.

17. A computer system comprising a processor, and a memory responsive to the processor, wherein the memory stores a program for integrating a website corresponding to a listing information for a user with an online social network, wherein the program is configured to cause the computer to:
receive the listing information;
update the website according to the listing information;
generate a post for the online social network according to the listing information; and
submit the generated post to the online social network.

18. A computer system according to claim 17, wherein the program is further configured to cause the computer to:
receive an account access information for the online social network;
store the access information in the memory;
retrieve, from the memory, the account access information; and
wherein submitting the generated post to the online social network comprises providing the account access information to the online social network.

19. A computer system according to claim 17, wherein receiving the listing information comprises receiving an input from the user.

20. A computer system according to claim 17, wherein receiving the listing information comprises receiving an input from a listing service.

21. A computer system according to claim 17, wherein the program is further configured to cause a computer to:
optimize at least one of the website and the post for a search engine based on the listing information.

22. A computer system according to claim 21, wherein:
the website comprises a plurality of words; and
optimizing the website for a search engine comprises:
determining the repetitiveness of at least one of the plurality of words;
comparing the at least one word with a list of predetermined words;
selecting the at least one word with a highest repetitiveness that exists in the list of predetermined words; and
associating the selected word with at least one of the website and the post.

23. A computer system according to claim 22, wherein associating the selected word comprises placing the selected word in at least one of a sitemap for the website, a source code for the website, an address of the website, and a tag of the post.

24. A computer system according to claim 17, wherein the listing information comprises a real estate listing.
